(19) United States
(12) Patent Application Publication
(10) Pub. No.: US 2025/0090953 A1
(43) Pub. Date: Mar. 20, 2025

(54) INFORMATION PROCESSING PROGRAM, INFORMATION PROCESSING METHOD, AND INFORMATION PROCESSING APPARATUS

(71) Applicant: KOEI TECMO GAMES CO., LTD., Yokohama-shi (JP)

(72) Inventors: Hidehiko NAKAJIMA, Kanagawa (JP); Masakazu HIRAYAMA, Kanagawa (JP)

(21) Appl. No.: 18/613,164

(22) Filed: Mar. 22, 2024

(30) Foreign Application Priority Data
Sep. 15, 2023 (JP) 2023-150586

(51) Int. Cl. A63F 13/56

(52) U.S. Cl. CPC A63F 13/56

(57) ABSTRACT

Provided are an information processing program, an information processing method, and an information processing apparatus that cause a computer to execute: starting a first period for making a first action of a player character, executed with an action of an opponent character as a trigger, executable in response to a first operation by a player; and receiving a second operation by the player for causing the player character to execute a second action, different from the first action, during the first period.

### CROSS-REFERENCE TO RELATED APPLICATION

This application is based on and claims priority under 35 USC 119 from Japanese Patent Application No. 2023-150586, filed on Sep. 15, 2023, the disclosure of which is incorporated by reference herein.

### BACKGROUND

### Technical Field

The present disclosure relates to an information processing program, an information processing method, and an information processing apparatus.

### Related Art

In a game in which a player character is damaged when being attacked by an opponent, a player character executes an action in response to an action of an opponent character. For example, in a battle between the characters, a counter that counteracts in accordance with the attack of the opponent is known as a type of attack with respect to the opponent.

As such a game, for example, Japanese Patent Application Laid-Open (JP-A) No. 2007-244740 discloses a technology in which a player character is caused to execute a counter action when a player performs an operation at an appropriate timing with respect to an attack of an opponent character.

In the above-described game, a first period for receiving execution of a first action is started when the player performs a first operation to make the first action executable. For example, in the game in which the counter action can be executed as described in JP-A No. 2007-244740, a first period for receiving the counter action is started when the player performs a first operation to make the counter action executable. When the player character is attacked by the opponent character within the first period, for example, the player character executes the counter.

However, for example, in a case in which the player desires to execute a second action different from the first action during the first period, an action other than the first action is not received during the first period, for example, even if the player determines that the first action is not established. Therefore, there is a disadvantage that the player cannot select the second action different from the first action until at least the first period elapses after the first operation is performed.

### SUMMARY

An object of the disclosure is to provide an information processing program, an information processing method, and an information processing apparatus that enable a player to select a second action different from a first action even in a first period in which the first action is made executable.

An information processing program according to a first aspect causes a computer to execute: starting a first period for making a first action of a player character, executed with an action of an opponent character as a trigger, executable in response to a first operation by a player; and receiving a second operation by the player for causing the player character to execute a second action, different from the first action, during the first period.

An information processing program according to a second aspect is the information processing program according to the first aspect, in which the player character is in a state of being affected by an action of the opponent character in a case in which the second action is not performed after the first period ends.

An information processing program according to a third aspect is the information processing program according to the first or second aspect, in which the first operation and the second operation are identical.

An information processing program according to a fourth aspect is the information processing program according to the third aspect causing the computer to further execute: starting a second period for receiving the second operation after the start of the first period; and executing the second action in a case in which the second operation by the player is received during the second period.

An information processing program according to a fifth aspect is the information processing program according to any one of the first to fourth aspects, in which the second action is an action that is more disadvantageous for the player than the first action.

An information processing program according to a sixth aspect is the information processing program according to the fourth aspect causing the computer to further execute: starting a third period after the second period ends; and making a transition to the first period in a case in which the first operation by the player is received during the third period.

An information processing program according to a seventh aspect is the information processing program according to any one of the first to sixth aspects causing the computer to further execute making a transition to the first period in a case in which the first operation by the player is received after the first action is completed.

An information processing program according to an eighth aspect is the information processing program according to the seventh aspect causing the computer to further execute changing an effect of the first action to be more advantageous for the player character as a time from reception of the first operation to reception of an attack from the opponent character is shorter.

An information processing method according to a ninth aspect including: starting, by a computer, a first period for making a first action of a player character, executed with an action of an opponent character as a trigger, executable in response to a first operation by a player; and receiving, by the computer, a second operation by the player for causing the player character to execute a second action, different from the first action, during the first period.

An information processing apparatus according to a tenth aspect includes a processor, the processor being configured to: start a first period for making a first action of a player character, executed with an action of an opponent character as a trigger, executable in response to a first operation by a player; and receive a second operation by the player for causing the player character to execute a second action, different from the first action, during the first period.

According to the disclosure, it is possible to provide the information processing program, the information processing method, and the information processing apparatus that enable the player to select the second action different from the first action even in the first period in which the first action is made executable.

### BRIEF DESCRIPTION OF THE DRAWINGS

Exemplary embodiments of the present disclosure will be described in detail based on the following figures, wherein:

FIG. 1 is a block diagram illustrating an example of a hardware configuration of an information processing apparatus;

FIG. 2 is a diagram for describing a counter waiting action;

FIG. 3 is a block diagram illustrating an example of a functional configuration of the information processing apparatus;

FIG. 4 is a diagram for describing a reinputtable period;

FIG. 5 is a diagram for describing a counter action;

FIG. 6 is a diagram for describing an avoidance action;

FIG. 7 is a diagram illustrating an example of a display mode;

FIG. 8 is a flowchart illustrating an example of a period control process; and

FIG. 9 is a flowchart illustrating an example of an action execution process.

### DETAILED DESCRIPTION

Hereinafter, exemplary embodiments of the technology of the disclosure will be described in detail with reference to the drawings.

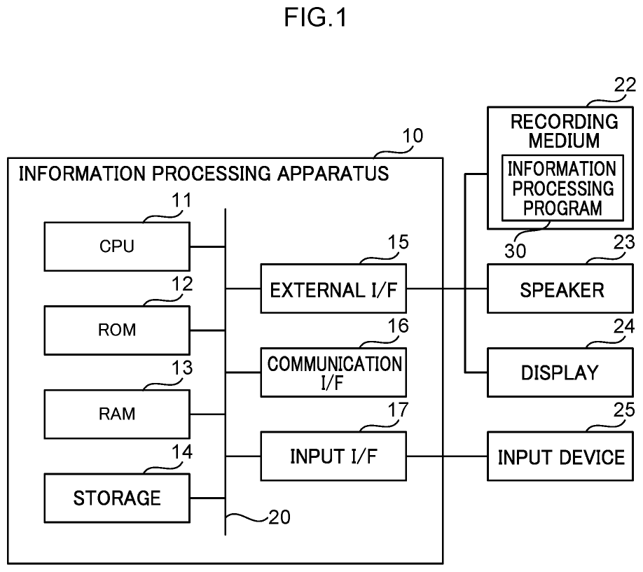

First, a hardware configuration of an information processing apparatus 10 according to the embodiment will be described with reference to FIG. 1. The information processing apparatus 10 is, for example, a home game machine, a portable game machine, a business game machine, a smartphone, a tablet terminal, a personal computer, or the like. In the embodiment, an example in which the home game machine is applied as the information processing apparatus 10 will be described. The information processing apparatus 10 is an example of a computer.

As illustrated in FIG. 1, the information processing apparatus 10 includes a central processing unit (CPU) 11, a read only memory (ROM) 12, a random access memory (RAM) 13, a storage 14, an external interface (I/F) 15, a communication I/F 16, and an input I/F 17. The CPU 11, the ROM 12, the RAM 13, the storage 14, the external I/F 15, the communication I/F 16, and the input I/F 17 are connected to be capable of communicating with each other via a bus 20.

The CPU 11 is a central processing unit, and executes various programs and controls each unit. The CPU 11 is an example of a processor. The ROM 12 stores various programs and various types of data. The RAM 13 temporarily stores programs or data as a work area. The storage 14 includes a storage device such as a hard disk drive (HDD), a solid state drive (SSD), or a flash memory, and stores various programs and various types of data.

The external I/F 15 is an interface configured to connect various external devices to the information processing apparatus 10. In the embodiment, a recording medium 22, a speaker 23, and a display 24 are connected to the external I/F 15.

As the recording medium 22, a compact disk read only memory (CD-ROM), a digital versatile disk read only memory (DVD-ROM), a universal serial bus (USB) memory, an SD memory card, or the like is used. The recording medium 22 stores an information processing program 30 configured to execute a predetermined game in the information processing apparatus 10. The CPU 11 reads the information processing program 30 from the recording medium 22 via the external I/F 15, and executes the information processing program 30 using the RAM 13 as the work area. Note that the information processing program 30 is not limited to an aspect of being stored in the recording medium 22, and may be stored in advance in the storage 14 or may be downloadable to the information processing apparatus 10 via the communication I/F 16.

The speaker 23 outputs various sounds. The speaker 23 may be integrated with the information processing apparatus 10 or may be integrated with the display 24. The display 24 is, for example, a liquid crystal display or an organic electro luminescence (EL) display, and displays various types of information. The display 24 may be integrated with a touch panel. In addition, the display 24 may be integrated with the information processing apparatus 10.

The communication I/F 16 is an interface configured to connect the information processing apparatus 10 to a network. For the communication I/F 16, for example, a wired communication standard such as Ethernet (registered trademark) or a fiber distributed data interface (FDDI), or a wireless communication standard such as 4G, 5G, or Wi-Fi (registered trademark) is used.

The input I/F 17 is an interface configured to connect an input device 25 to the information processing apparatus 10. The input device 25 is a controller having an operation button, a direction key, and the like, a mouse, a keyboard, or the like, and is used to perform various inputs. A user operates the game using the input device 25. Operation information indicating a content of an input operation performed by the user using the input device 25 is stored in the RAM 13. The input device 25 may be integrated with the information processing apparatus 10. In addition, the input device 25 may be detachably attached to the information processing apparatus 10. In addition, the number of the input devices 25 may be one or more. In addition, the input device 25 may be a touch panel integrated with the display 24.

The information processing apparatus 10 of the embodiment provides the game in which a player character controlled by a player as the user of the information processing apparatus 10 in a virtual space on the game does a battle with an enemy character not controlled by the player. In the game, the enemy character as a battle opponent is arranged on a path along which the player character travels. The enemy character as the battle opponent may be a so-called non-player character (NPC) that is not controlled by the player, a character controlled by a player different from the player who operates the player character, or a combination of this character and the NPC. In the embodiment, the player character and the enemy character as the battle opponent are collectively referred to as a “character” when the both are not distinguished. Note that the character is a person, an animal, a robot, a machine, an imaginary creature, or the like appearing in the game, and a type of the character is not limited. Note that the enemy character of the embodiment is an example of an opponent character of the disclosure.

The information processing apparatus 10 of the embodiment starts a first period in which a first action of the player character to be executed with the enemy character as a trigger is executable in response to a first operation by the player, and receives a second operation by the player for causing the player character to execute a second action different from the first action during the first period.

As described above, the first action is an action executed by the player character with the action of the enemy character as the trigger, and the player character faces the enemy character in order to wait for the execution of the first action during the first period. Examples of the first action include a counter action. In the embodiment, a case in which the first action is the counter action will be described. The term “counter” refers to making an attack on the enemy character with the action of the enemy character as the trigger, and is also referred to as a counter attack, a counter offense, and a parry. In addition, the “counter action” is an action executed by the player character to perform a counter.

In the embodiment, the second action is an action that is more disadvantageous for the player than the first action. Examples of the second action include an avoidance action and a defense action. In the embodiment, a case in which the second action is the avoidance action will be described. The term “avoidance” refers to avoiding an attack on the enemy character. In addition, the term “avoidance action” is an action executed by the player character to perform avoidance.

Examples of a combination of the first action and the second action include the following cases. A case in which the first action is an attack action of making any attack on the enemy character and the second action is the avoidance action. A case in which the first action is the attack action and the second action is the defense action of guarding against an action of the enemy character. A case in which the first action is the avoidance action and the second action is the defense action. A case in which the first action is the avoidance action including an invincible period, which will be described in detail later, and the second action is the avoidance action not including the invincible period. A case in which the first action is the defense action executed by the character player without being in a stiff state, and the second action is the defense action executed by the player character in a stiff state. A case in which the first action is the defense action executed in a state where a status of the player character is improved, and the second action is the defense action executed in a state where the status of the player character is not changed.

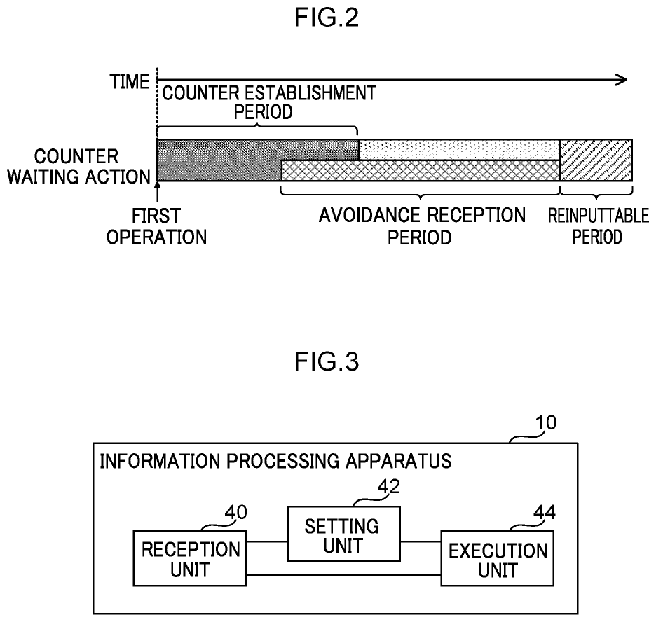

In the information processing apparatus 10 of the embodiment, in a counter waiting action executed by the player character, the counter action of the player character is executed with the action of the enemy character as a trigger during a counter establishment period started with the first operation as a trigger. In the counter waiting action, when the second operation is received during the counter establishment period, the player character is caused to execute the avoidance action. As illustrated in FIG. 2, the counter waiting action includes the counter establishment period, an avoidance reception period, and a reinputtable period. In FIG. 2, time elapses rightward from the first operation input timepoint. As described above, a case in which the counter action is an example of the first action of the disclosure, the avoidance action is an example of the second action of the disclosure, the counter establishment period is an example of the first period of the disclosure, the avoidance reception period is an example of the second period of the disclosure, and the reinputtable period is an example of a third period of the disclosure will be described in the embodiment.

When the first operation is received, the information processing apparatus 10 starts the counter establishment period. The counter establishment period is a period in which the player character executes the counter action with an attack of the enemy character as a trigger. Therefore, in the counter establishment period, the player character is not damaged by the attack of the enemy character, or the damage by the attack of the enemy character is extremely small as compared with a case in which the counter action is not performed.

During the counter establishment period, the counter establishment period is not started again even if the first operation is performed. In other words, the first operation is not received during the counter establishment period.

As illustrated in FIG. 2, the information processing apparatus 10 starts the avoidance reception period as the second period during the counter establishment period. Therefore, the avoidance reception period includes a period overlapping with the counter establishment period. In addition, the avoidance reception period continues even after the end of the counter establishment period. In other words, the avoidance reception period ends after the end of the counter establishment period. The avoidance reception period is a period in which the player character executes the avoidance action when the reception unit 40 receives the second operation. In a case in which the second operation is received in a period in which the counter establishment period and the avoidance reception period overlap, the avoidance action is executed instead of the counter waiting action. In a case in which the player character does not perform the avoidance action after the counter establishment period ends without executing the counter action in the counter establishment period, the player character is in a state of being affected by an action of the enemy character. Therefore, in the embodiment, in the avoidance reception period after the end of the counter establishment period, the player character is damaged by an attack of the enemy character if the player character does not perform the avoidance action. In the avoidance reception period of the embodiment, the avoidance action is executed each time the second operation is performed. For example, when the player consecutively pushes a button for the second operation, the avoidance action is repeatedly executed.

Note that the avoidance action is not executed even if the second operation is performed from the start of the counter establishment period to the start of the avoidance reception period. In other words, the second operation is not received from the start of the counter establishment period to the start of the avoidance reception period.

As illustrated in FIG. 2, the information processing apparatus 10 starts the reinputtable period as the third period after the end of the avoidance reception period. The reinputtable period is a period for transitioning to the counter establishment period when the reception unit 40 receives the first operation by the player during the period. That is, the player character can be caused to consecutively perform the counter action when the first operation is received in the reinputtable period.

Note that a length of each of the counter establishment period, the avoidance reception period, the reinputtable period, a period from the start of the counter establishment period to the start of the avoidance reception period, and the period in which the counter establishment period and the avoidance reception period overlap is not limited. For example, the length may be variable depending on conditions of the enemy character and the player character. Examples of the conditions in this case include power of the enemy character, a type of equipment of the player character, and the like.

Next, a functional configuration of the information processing apparatus 10 will be described with reference to FIG. 3. As illustrated in FIG. 3, the information processing apparatus 10 includes a reception unit 40, a setting unit 42, and an execution unit 44. The CPU 11 executes the information processing program 30 to function as the reception unit 40, the setting unit 42, and the execution unit 44.

The reception unit 40 receives the first operation by the player for causing the player character to execute the counter action. In addition, the reception unit 40 receives the second operation by the player for causing the player character to execute the second action. As an example, the first operation and the second operation are the same operation in the embodiment. Examples of the first operation and the second operation include pressing the same button of the input device 25.

The setting unit 42 starts the counter establishment period, which is the first period for making the counter action executable, in response to the first operation by the player. In addition, when a predetermined time elapses after the start of the counter establishment period, the setting unit 42 ends the counter establishment period.

After the start of the counter establishment period, the setting unit 42 starts the avoidance reception period that is the second period for receiving the second operation. In addition, the setting unit 42 ends the avoidance reception period when a predetermined time elapses after the start of the avoidance reception period.

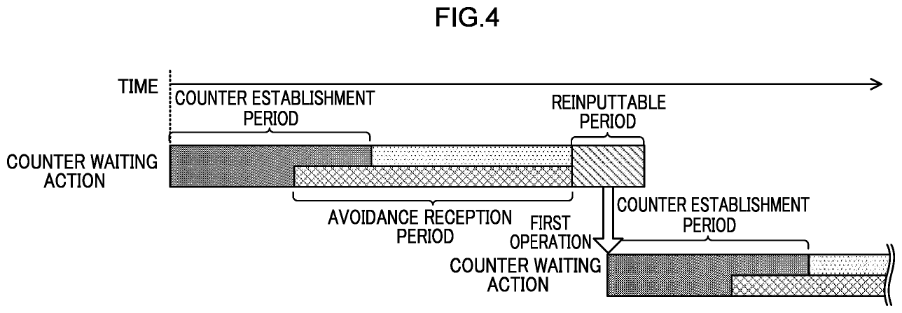

After the end of the avoidance reception period, the setting unit 42 of the embodiment starts the reinputtable period as the third period. In addition, the setting unit 42 ends the reinputtable period and transitions to the counter establishment period when the reception unit 40 receives the first operation during the reinputtable period as illustrated in FIG. 4. In this case, the counter waiting action is executed again, and the counter action can be executed consecutively. In a case in which the reception unit 40 does not receive the first operation during the reinputtable period, the setting unit 42 ends the reinputtable period when a predetermined time elapses from the start of the reinputtable period.

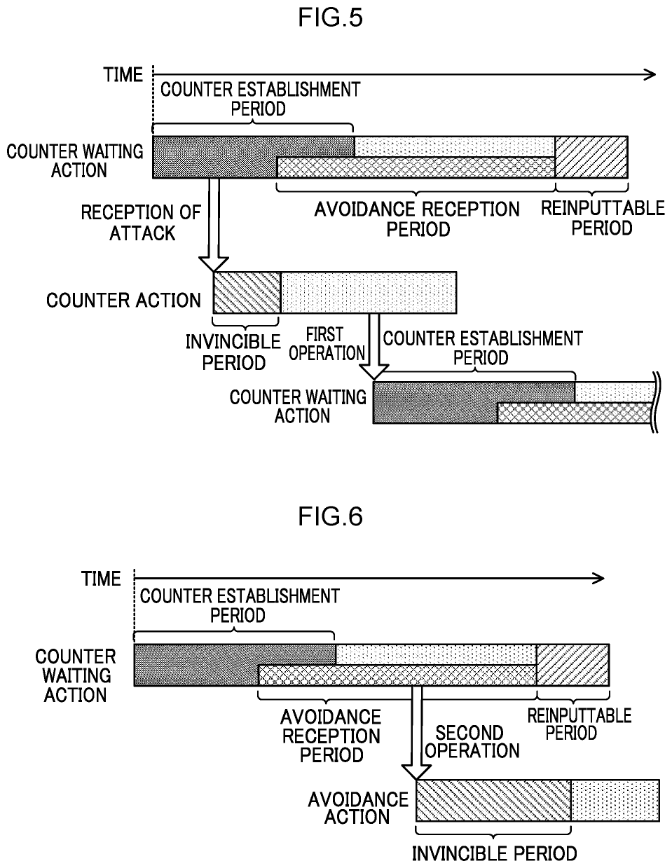

The execution unit 44 executes the counter action as the first action with an action of the enemy character as a rigger during the counter establishment period. As an example, in the embodiment, when the execution unit 44 causes the player character to execute the counter action when an attack from the enemy character is received during the counter establishment period as illustrated in FIG. 5. As illustrated in FIG. 5, the counter action of the embodiment includes an invincible period in which no damage is caused by the attack of the enemy character. As a result, the player character can perform the counter with respect to the enemy character without being affected by the attack of the enemy character. An aspect of applying an effect of the counter of the player character on the enemy character is not limited. For example, the effect of the counter of the player character on the enemy character may be varied depending on a time from the start of the counter establishment period to reception of the attack of the enemy character, power of the enemy character, a type of attack of the enemy character, equipment of the player character, and the like. For example, the effect of the counter action on the enemy character may be changed so as to be more advantageous for the player character as a time from reception of the first operation to reception of the attack from the enemy character is shorter. As an example of this case, damage given to the enemy character is made larger as the time from the reception of the first operation to the reception of the attack from the enemy character is shorter.

In addition, for example, in a case in which the enemy character is weak, the player character may perform the counter with respect to the enemy character such that it is possible to prevent reception of the damage caused by the attack having triggered the counter action and to frighten the enemy character. In addition, for example, in a case in which the enemy character is strong, the enemy character may continue acting without any change, but is not damaged by the attack having triggered the counter action even if the player character performs the counter with respect to the enemy character.

In the embodiment, as illustrated in FIG. 5, in a case in which the reception unit 40 receives the first operation again after a lapse of the invincible period during a period in which the counter action is executed by the execution unit 44, the execution unit 44 completes the counter action. In addition, the setting unit 42 transitions to the counter establishment period. In this manner, in a case in which the counter is successful, the counter action can be consecutively performed.

As illustrated in FIG. 6, when the reception unit 40 receives the second operation during the avoidance reception period, the execution unit 44 executes the avoidance action as the second action. As illustrated in FIG. 6, the avoidance action of the embodiment includes the invincible period in which no damage is caused by an attack of the enemy character. As a result, the player character can avoid the attack of the enemy character without being affected by the attack of the enemy character. As illustrated in FIGS. 5 and 6, the invincible period in the avoidance action is longer than the invincible period in the counter action. Note that how the player character avoids the attack of the enemy character is not limited. For example, a distance to retreat from the enemy character may be varied depending on power of the enemy character, a type of attack of the enemy character, equipment of the player character, and the like.

In the avoidance reception period, the avoidance action can be repeatedly performed as described above. That is, during the avoidance reception period, the execution unit 44 repeatedly executes the avoidance action in response to the second operation consecutively received by the reception unit 40. In this manner, in a case in which the player character fails in the counter action, the failure can be recovered by the avoidance action in the information processing apparatus 10 of the embodiment. In particular, since the first operation and the second operation are the same operation of pressing the same button in the embodiment, when the player consecutively hits the button for the first operation, the failure can be recovered by the avoidance action even if the counter action fails.

In addition, in the embodiment, the counter action is not executed by executing the avoidance action in response to the second operation in the period in which the counter establishment period and the avoidance reception period overlap. Therefore, in the period in which the counter establishment period and the avoidance reception period overlap, the player selects whether to aim at the counter or to safely avoid the attack of the enemy character by avoidance, and the number of options increases, which provides strategic characteristics.

In addition, the execution unit 44 of the embodiment controls display of various types of information on the display 24. In particular, the execution unit 44 performs display in response to an action executed by the player character.

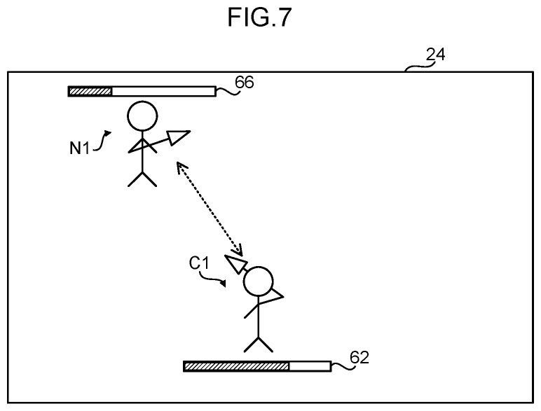

FIG. 7 illustrates an example of a display mode displayed on the display 24 by the execution unit 44. FIG. 7 illustrates an example in which there are one player character C1 and one enemy character N1. The execution unit 44 displays the player character C1 in a mode corresponding to an action executed by the player character C1. In addition, the execution unit 44 displays a gauge indicating hit points of the player character C1 in a display area 62 below the player character C1. When the gauge displayed in the display area 62 is empty (the hit points become 0), the player character C1 is in a dead state. Further, the execution unit 44 displays the enemy character N1 in a mode corresponding to an action executed by the enemy character N1. In addition, the execution unit 44 displays a gauge indicating hit points of the enemy character N1 in a display area 66 above the enemy character N1. When the gauge displayed in the display area 66 is empty (the hit points become 0), the enemy character N1 is in a dead state.

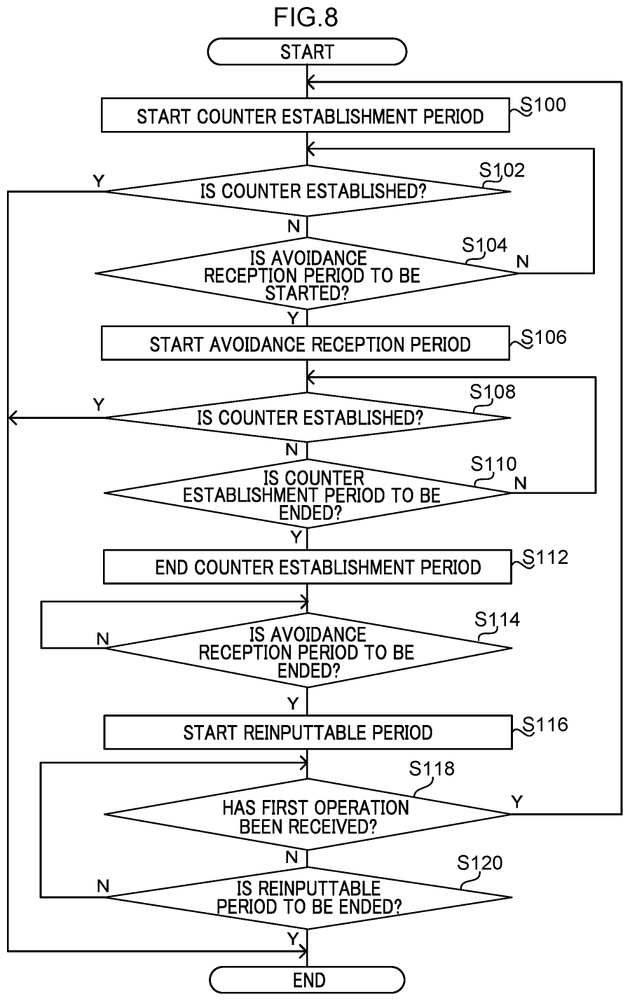

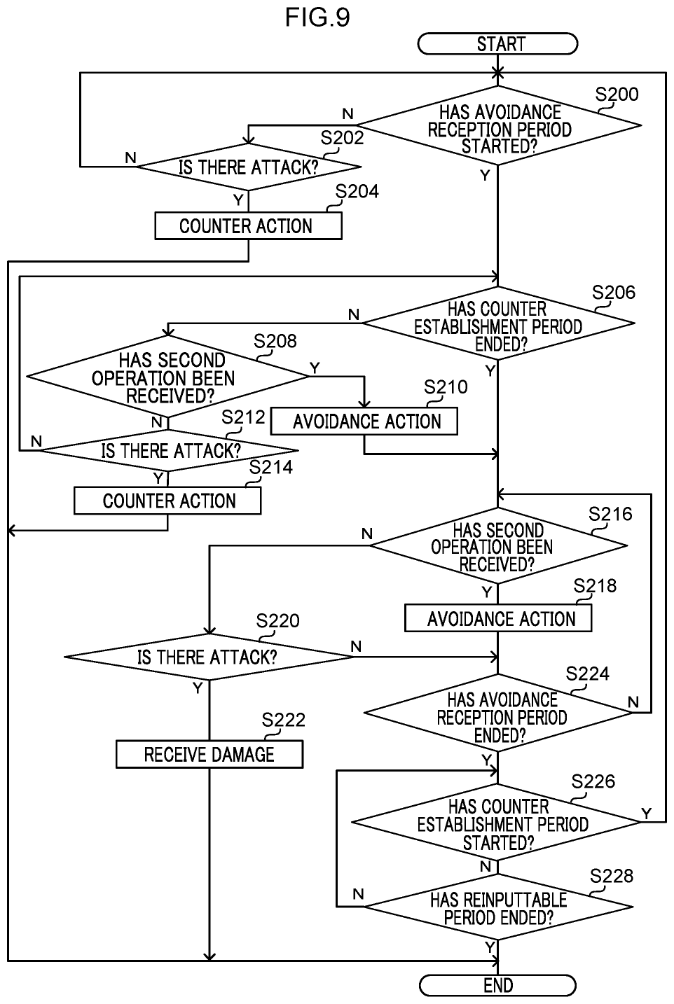

Next, an operational effect of the information processing apparatus 10 will be described with reference to FIGS. 8 and 9. As the CPU 11 executes the information processing program 30, a period control process illustrated in FIG. 8 and an action execution process illustrated in FIG. 9 are executed.

First, the period control process illustrated in FIG. 8 will be described. In the period control process, the setting unit 42 performs control related to the counter establishment period, the avoidance reception period, and the reinputtable period. As an example, the period control process of the embodiment is executed when the reception unit 40 receives the first operation.

In step S100 of FIG. 8, the setting unit 42 starts the counter establishment period as described above. In the next step S102, the setting unit 42 determines whether or not the counter is established, that is, whether or not the player character has executed the counter action. In a case in which the counter is established, a positive determination is made in the determination in step S102, and the period control process illustrated in FIG. 8 is ended. On the other hand, in a case in which the counter is not established, a negative determination is made in the determination in step S102, and the processing proceeds to step S104.

In the next step S104, the setting unit 42 determines whether or not to start the avoidance reception period. A negative determination is made in the determination in step S104 until reaching a timing to start the avoidance reception period, and the processing returns to step S102. On the other hand, a positive determination is made in the determination in step S104 when reaching the timing to start the avoidance reception period, and the processing proceeds to step S106. Then, in step S106, the setting unit 42 starts the avoidance reception period.

In the next step S108, the setting unit 42 determines whether or not the counter is established similarly to the step S102. In a case in which the counter is established, a positive determination is made in the determination in step S108, and the period control process illustrated in FIG. 8 is ended. On the other hand, in a case in which the counter is not established, a negative determination is made in the determination in step S108, and the processing proceeds to step S110.

In the next step S110, the setting unit 42 determines whether or not to end the counter establishment period. A negative determination is made in the determination in step S110 until reaching a timing to end the counter establishment period, and the processing returns to step S108. On the other hand, a positive determination is made in the determination in step S110 when reaching the timing to end the counter establishment period, the processing proceeds to step S112, and the setting unit 42 ends the counter establishment period in step S112.

In the next step S114, the setting unit 42 determines whether or not to end the avoidance reception period. A negative determination is made in the determination in step S114 until reaching a timing to end the avoidance reception period. On the other hand, a positive determination is made in the determination in step S114 when reaching the timing to end the avoidance reception period, and the processing proceeds to step S116.

In step S116, the setting unit 42 starts the reinputtable period as described above. In the next step S118, the setting unit 42 determines whether or not the reception unit 40 has received the first operation. In a case in which the reception unit 40 has received the first operation, a positive determination is made in the determination in step S118, the processing returns to step S100, and the processing from steps S100 to S116 is repeated. On the other hand, in a case in which the reception unit 40 has not received the first operation, a negative determination is made in the determination in step S118, and the processing proceeds to step S120.

In step S120, the setting unit 42 determines whether or not to end the reinputtable period, makes a negative determination in the determination in step S120 until reaching a timing to end the reinputtable period, and returns to step S118. On the other hand, a positive determination is made in the determination in step S120 when reaching the timing to end the reinputtable period, and the period control process illustrated in FIG. 8 ends. In this manner, the start and end of each of the counter establishment period, the avoidance reception period, and the reinputtable period can be controlled through the period control process illustrated in FIG. 8.

Next, the action execution process illustrated in FIG. 9 will be described. In the action execution process, the execution unit 44 causes the player character to execute an action. As an example, the action execution process of the embodiment is executed when the reception unit 40 receives the first operation. That is, the action execution process of the embodiment is executed when the reception unit 40 starts the counter establishment period.

In step S200 of FIG. 9, the execution unit 44 determines whether or not the avoidance reception period has started. In a case in which the avoidance reception period has not started yet, a negative determination is made in the determination in step S200, and the processing proceeds to step S202. In step S202, the execution unit 44 determines whether or not there is an attack from the enemy character. In a case in which there is no attack from the enemy character, a negative determination is made in the determination in step S202, and the processing returns to step S200. On the other hand, in a case in which there is an attack from the enemy character, a positive determination is made in the determination in step S202, and the processing proceeds to step S204. In step S204, the execution unit 44 causes the player character to execute the counter action as described above. When the processing in step S204 ends, the action execution process illustrated in FIG. 9 ends. In this manner, the player character executes the counter action when being attacked by the enemy character until the avoidance reception period starts.

On the other hand, when the avoidance reception period starts, a positive determination is made in the determination in step S200, and the processing proceeds to step S206. In step S206, the execution unit 44 determines whether or not the counter establishment period has ended. Until the counter establishment period ends, a negative determination is made in the determination in step S206, and the processing proceeds to step S208.

In step S208, the execution unit 44 determines whether or not the reception unit 40 has received the second operation. In a case in which the reception unit 40 has received the second operation, a positive determination is made in the determination in step S208, and the processing proceeds to step S210. In step S210, the execution unit 44 causes the player character to execute the avoidance action as described above, and then, proceeds to step S216. In this manner, since the avoidance action can be consecutively executed during the avoidance reception period in the embodiment, the processing proceeds to step S216 after the processing in step S210. However, unlike the embodiment, the action execution process illustrated in FIG. 9 ends when the processing in step S210 ends in a case in which it is difficult to consecutively execute the avoidance action, in other words, in a case in which the avoidance reception period ends if the avoidance action is executed.

On the other hand, in a case in which the reception unit 40 has not received the second operation, a negative determination is made in the determination in step S208, and the processing proceeds to step S212. In step S212, the execution unit 44 determines whether or not there is an attack from the enemy character. In a case in which there is no attach from the enemy character, a negative determination is made in the determination in step S212, and the processing returns to step S206. On the other hand, in a case in which there is an attack from the enemy character, a positive determination is made in the determination in step S212, and the processing proceeds to step S214. In step S214, the execution unit 44 causes the player character to execute the counter action as described above. When the processing in step S214 ends, the action execution process illustrated in FIG. 9 ends. In this manner, when there is an attack of the enemy character in the period in which the counter establishment period and the avoidance reception period overlap, the avoidance action is executed if the reception unit 40 has received the second operation, and the counter action is executed if the reception unit 40 has not received the second operation.

On the other hand, in a case in which the counter establishment period ends in step S206, a positive determination is made in the determination, and the processing proceeds to step S216. In step S216, the execution unit 44 determines whether or not the reception unit 40 has received the second operation. In a case in which the reception unit 40 has not received the second operation, a negative determination is made in the determination, and the processing proceeds to step S220. In step S220, the execution unit 44 determines whether or not there is an attack from the enemy character. In a case in which there is no attack from the enemy character, a negative determination is made in the determination in step S220, and the processing proceeds to step S224. On the other hand, in a case in which there is an attack from the enemy character, a positive determination is made in the determination in step S220, and the processing proceeds to step S222. In step S222, the execution unit 44 performs processing when the player character is damaged by the attack of the enemy character. In other words, the execution unit 44 applies the damage to the player character caused by the attack of the enemy character. When the processing in step S222 ends, the action execution process illustrated in FIG. 9 ends.

On the other hand, in a case in which the reception unit 40 has received the second operation in step S216, a positive determination is made in the determination, and the processing proceeds to step S218. In step S218, the execution unit 44 causes the player character to execute the avoidance action as described above, and then, proceeds to step S224. As described above, since the avoidance action can be consecutively executed during the avoidance reception period in the embodiment, the processing proceeds to step S224 after the processing in step S218. However, unlike the embodiment, the action execution process illustrated in FIG. 9 ends when the processing in step S218 ends in a case in which the avoidance reception period ends when the avoidance action is executed.

In step S224, the execution unit 44 determines whether or not the avoidance reception period has ended. Until the avoidance reception period ends, a negative determination is made in the determination in step S224, the processing returns to step S216, and the processing from steps S216 to S222 is repeated. In this manner, when the player character is attacked by the enemy character in the avoidance reception period after the counter establishment period, the avoidance action is executed if the second operation has been received, and the player character is damaged if the second operation has not been received.

On the other hand, when the avoidance reception period ends, a positive determination is made in the determination in step S224, and the processing proceeds to step S226. As described above, the reinputtable period starts when the avoidance reception period ends. In the reinputtable period, when the reception unit 40 receives the first operation, the counter waiting action is executed again, and the counter establishment period is started. Therefore, in step S226, the execution unit 44 determines whether or not the counter establishment period has started. In a case in which the counter establishment period has started, a positive determination is made in the determination in step S226, the processing returns to step S200, and the processing from steps S200 to S224 is repeated.

On the other hand, in a case in which the counter establishment period has not started, a negative determination is made in the determination in step S226, and the processing proceeds to step S228. In step S228, the execution unit 44 determines whether or not the reinputtable period has ended. A negative determination is made in the determination in step S228 until the reinputtable period ends, and the processing returns to step S226. On the other hand, when the reinputtable period ends, a positive determination is made in the determination in step S228, and the action execution process illustrated in FIG. 9 ends.

As described above, the information processing apparatus 10 according to the embodiment starts the first period in which the counter action can be executed as the first action of the player character executed with the action of the enemy character as the trigger in response to the first operation by the player. In addition, the information processing apparatus 10 receives the second operation by the player for causing the player character to execute the avoidance action as the second action different from the first action during the first period. In this manner, the player can select the second action different from the first action even in the first period in which the first action is made executable according to the information processing apparatus 10 of the embodiment.

In particular, in a case in which the first action is the counter action as in the embodiment, it is important to achieve a timing of performing the second operation, but it is not easy to achieve the timing in accordance with an attack of the enemy character in many cases. In addition, there is a high risk when the counter action fails. In regard to this, recovery from the failure can be performed since the avoidance action can be executed during the execution of the counter waiting action in the information processing apparatus 10 of the embodiment. As a result, the player can actively aim at the counter according to the information processing apparatus 10 of the embodiment.

Although the case in which the first action of the disclosure is the counter action and the second action of the disclosure is the avoidance action has been described in the embodiment, each of the first action and the second action is not limited thereto. For example, the first action may be the counter action, and the second action may be the defense action for defending against an attack from the enemy character. In addition, the first action may be the avoidance action, and the second action may be the defense action. In addition, the first action may be the avoidance action described above, and the second action may be an avoidance action that does not include the invincible period unlike the avoidance action described above. Note that the avoidance action in the second action in this case can be said to be a different type of avoidance action from the avoidance action that is the first action. In this manner, even if the first action and the second action are actions having the same names, the types thereof may be different in some cases. At least one of the first action and the second action may be an action called parry or just guard of flicking or parrying an attack of the enemy at just the right timing using equipment such as a shield or a sword. In addition, the second action only needs to be different from the first action, and may be an action more advantageous than the first action.

In addition, the description has been given using the enemy character as an example of the opponent character of the disclosure in the embodiment, but the opponent character of the disclosure is not limited to the enemy character. For example, a character as an ally of the player character may also be an opponent.

In addition, various processes executed by the CPU 11 reading software (program) in the embodiment may be executed by various processors other than the CPU. Examples of the processors in this case include a programmable logic device (PLD) whose circuit configuration can be changed after manufacturing, such as a field-programmable gate array (FPGA), a dedicated electric circuit that is a processor having a circuit configuration exclusively designed for executing specific processing, such as an application specific integrated circuit (ASIC), and the like. In addition, various processes may be executed by one of the various processors, or may be executed by any combination of two or more processors of the same type or different types (for example, a plurality of FPGAs, a combination of a CPU and an FPGA, and the like). More specifically, a hardware structure of the various processors is an electric circuit in which circuit elements such as semiconductor elements are combined.

What is claimed is:

1. A non-transitory computer-readable recording medium in which an information processing program is recorded, the information processing program causing a computer to execute:
starting a first period for making a first action of a player character, executed with an action of an opponent character as a trigger, executable in response to a first operation by a player; and
receiving a second operation by the player for causing the player character to execute a second action, different from the first action, during the first period.

2. The non-transitory computer-readable recording medium in which the information processing program is recorded according to claim 1, wherein
the player character is in a state of being affected by an action of the opponent character in a case in which the second action is not performed after the first period ends.

3. The non-transitory computer-readable recording medium in which the information processing program is recorded according to claim 1, wherein
the first operation and the second operation are identical.

4. The non-transitory computer-readable recording medium in which the information processing program is recorded according to claim 1, the information processing program causing the computer to further execute:
starting a second period for receiving the second operation after the start of the first period; and
executing the second action in a case in which the second operation by the player is received during the second period.

5. The non-transitory computer-readable recording medium in which the information processing program is recorded according to claim 1, wherein
the second action is an action that is more disadvantageous for the player than the first action.

6. The non-transitory computer-readable recording medium in which the information processing program is recorded according to claim 4, the information processing program causing the computer to further execute:
starting a third period after the second period ends; and
making a transition to the first period in a case in which the first operation by the player is received during the third period.

7. The non-transitory computer-readable recording medium in which the information processing program is recorded according to claim 1, the information processing program causing the computer to further execute
making a transition to the first period in a case in which the first operation by the player is received after the first action is completed.

8. The non-transitory computer-readable recording medium in which the information processing program is recorded according to claim 1, the information processing program causing the computer to further execute
changing an effect of the first action to be more advantageous for the player character as a time from reception of the first operation to reception of an attack from the opponent character is shorter.

9. An information processing method comprising:
starting, by a computer, a first period for making a first action of a player character, executed with an action of an opponent character as a trigger, executable in response to a first operation by a player; and
receiving, by the computer, a second operation by the player for causing the player character to execute a second action, different from the first action, during the first period.

10. An information processing apparatus comprising
a processor, the processor being configured to:
start a first period for making a first action of a player character, executed with an action of an opponent character as a trigger, executable in response to a first operation by a player; and
receive a second operation by the player for causing the player character to execute a second action, different from the first action, during the first period.
